(19) United States
(12) Patent Application Publication
(10) Pub. No.: US 2015/0123883 A1
(43) Pub. Date: May 7, 2015

(54) Display With Hybrid Progressive-Simultaneous Drive Pattern

(71) Applicant: Apple Inc., Cupertino, CA (US)

(72) Inventors: Chin-Wei Lin, Cupertino, CA (US); Vasudha Gupta, Cupertino, CA (US); Young Bae Park, San Jose, CA (US)

(73) Assignee: Apple Inc., Cupertino, CA (US)

(21) Appl. No.: 14/071,428

(22) Filed: Nov. 4, 2013

(51) Int. Cl. G09G 3/32

(52) U.S. Cl. CPC G09G 3/3241; G09G 2320/0204
USPC 345/76

(57) ABSTRACT

A display may have an array of organic light-emitting diode display pixels. Each display pixel may have a light-emitting diode that emits light under control of a drive transistor. Each display pixel may also have control transistors for compensating and programming operations. The array of display pixels may have rows and columns. Row lines may be used to apply row control signals to rows of the display pixels. Column lines (data lines) may be used to apply display data and other signals to respective columns of display pixels. Display driver circuitry may simultaneously compensate multiple rows of the display pixels for drive transistor threshold voltage variations by supplying a common reference voltage over the data lines during a common compensation period. The display data may then be loaded into the rows sequentially before simultaneously commencing emission in each of the compensated and programmed rows.

### BACKGROUND

This relates generally to electronic devices with displays and, more particularly, to display driver circuitry for displays such as organic-light-emitting diode displays.

Electronic devices often include displays. For example, cellular telephones and portable computers include displays for presenting information to users.

Displays such as organic light-emitting diode displays have an array of display pixels based on light-emitting diodes. In this type of display, each display pixel includes a light-emitting diode and thin-film transistors for controlling application of a signal to the light-emitting diode to produce light.

Pixel-to-pixel variations in transistor threshold voltages and other characteristics can lead to undesired visible display artifacts. Conventional organic light-emitting diode displays use compensation schemes to compensate for pixel-to-pixel variations. Compensation operations ensure that the drive currents used to drive the light-emitting diodes are not influenced by transistor threshold voltage variations.

In a typical display driving scheme, display pixels in the display are loaded by row. Initially, the display pixels in a row are compensated. Following compensation, data is programmed into the compensated display pixels of the row. The amount of time consumed by the compensation process and the programming process is sometimes referred to as a row processing time or row time. Following completion of compensation and programming operations, the display pixels in the array emit light. The period of time during which the display pixels of a row emit light is sometimes referred to as the emission period.

With simultaneous emission schemes, the emission periods of all rows are synchronized following compensation and programming of the rows of the array. This type of approach restricts the fraction of time during which the display is emitting light relative to performing compensation and programming operations. Because emission does not begin until each of the rows has been compensated and programmed with data, the amount of time consumed by compensation and programming operations relative to the emission period can be to substantial. To prevent the display from being unacceptably dim, the magnitude of the drive current used during the emission period can be increased, but this shortens the lifetime of the light-emitting diodes in the display.

With progressive emission schemes, the emission period for each row is started as soon as the compensation and programming period for that row is complete. Because emission for each row is started after completion of a single compensation and programming period (i.e., after a single row time), displays that use progressive emission schemes may be more efficient than displays using simultaneous emission schemes. However, displays with large numbers of rows face challenges. This is because the amount of time available for compensating and programming each row is inversely proportional to the number of rows in each image frame. In a display with a large number or rows, there may be insufficient time available to individually compensate and program each row as required for progressive emission schemes.

It would therefore be desirable to be able to more effectively control the operation of a display such as an organic light-emitting diode display.

### SUMMARY

An electronic device may include a display having an array of display pixels. The display pixels may be organic light-emitting diode display pixels. Each display pixel may have an organic light-emitting diode that emits light. A drive transistor in each display pixel may apply current to the organic light-emitting diode in that display pixel. The drive transistor may be characterized by a threshold voltage.

Each display pixel may have control transistors that are used in compensating the display pixels for variations in the threshold voltages. During compensation operations, a reference voltage may be provided to the display pixels. The control transistors may also be used in loading display data into the display pixels during programming operations and in controlling display pixel emission operations.

The array of display pixels may have rows and columns. Row lines may be used to apply row control signals to the control transistors in rows of the display pixels. Column lines (data lines) may be used to apply display data and other signals to respective columns of display pixels.

Display driver circuitry may simultaneously compensate multiple rows of the display pixels for drive transistor threshold voltage variations by simultaneously supplying a common reference voltage to each of the multiple rows over the data lines. The display data may then be loaded into the compensated rows sequentially. After the compensated rows have been loaded with display data, the display driver circuitry may simultaneously commence an emission period for each of these multiple rows. This process may repeat continuously, so that frames of data are displayed.

### BRIEF DESCRIPTION OF THE DRAWINGS

FIG. 1 is a diagram of an illustrative display such as an organic light-emitting diode display having an array of organic light-emitting diode display pixels in accordance with an embodiment.

FIG. 2 is a diagram of an illustrative organic light-emitting diode display pixel of the type that may be used in a display in accordance with an embodiment.

FIG. 3 is a diagram showing how a frame time for a row of display pixels is made up of a row time and an emission period in accordance with an embodiment.

FIG. 4 is a diagram of an illustrative progressive-simultaneous display drive scheme in accordance with an embodiment.

FIG. 5 is a diagram showing how rows of data are displayed within sequential image frames using an illustrative progressive-simultaneous display drive scheme in accordance with an embodiment.

FIG. 6 is a timing diagram showing control signals involved in driving a display using an illustrative progressive-simultaneous drive scheme in accordance with an embodiment.

### DETAILED DESCRIPTION

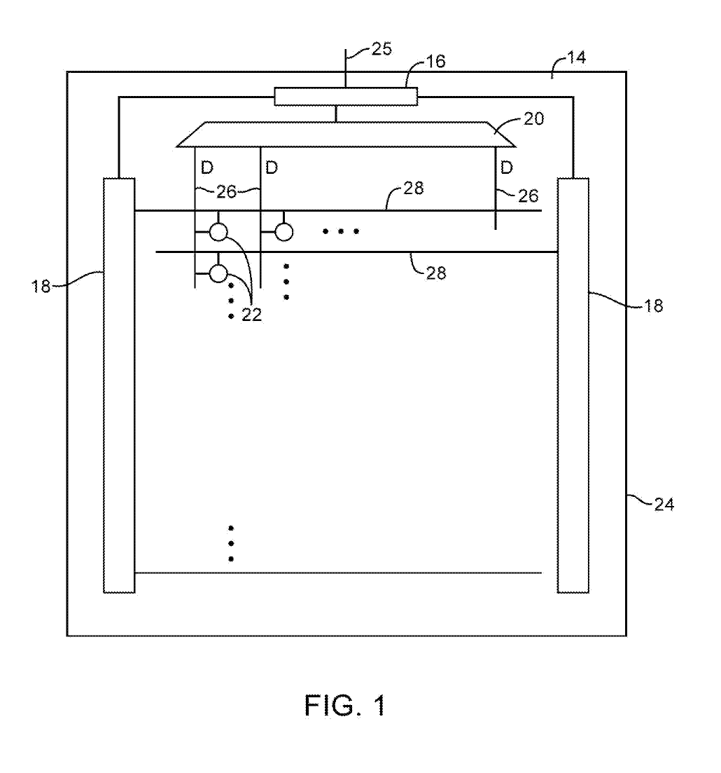

A display in an electronic device may be provided with driver circuitry for displaying images on an array of display pixels. An illustrative display is shown in FIG. 1. As shown in FIG. 1, display 14 may have one or more layers such as substrate 24. Layers such as substrate 24 may be formed from planar rectangular layers of material such as planar glass layers. Display 14 may have an array of display pixels 22 for displaying images for a user. The array of display pixels 22 may be formed from rows and columns of display pixel structures on substrate 24. These structures may include thin-film transistors such as polysilicon thin-film transistors, semiconducting oxide thin-film transistors, etc. There may be any suitable number of rows and columns in the array of display pixels 22 (e.g., ten or more, one hundred or more, or one thousand or more).

Display driver circuitry such as display driver integrated circuit 16 may be coupled to conductive paths such as metal traces on substrate 24 using solder or conductive adhesive. Display driver integrated circuit 16 (sometimes referred to as a timing controller chip) may contain communications circuitry for communicating with system control circuitry over path 25. Path 25 may be formed from traces on a flexible printed circuit or other cable. The control circuitry may be located on a main logic board in an electronic device such as a cellular telephone, computer, television, set-top box, media player, portable electronic device, or other electronic equipment in which display 14 is being used. During operation, the control circuitry may supply display driver integrated circuit 16 with information on images to be displayed on display 14. To display the images on display pixels 22, display driver integrated circuit 16 may supply clock signals and other control signals to display driver circuitry such as row driver circuitry 18 and column driver circuitry 20. Row driver circuitry 18 and/or column driver circuitry 20 may be formed from one or more integrated circuits and/or one or more thin-film transistor circuits.

Row driver circuitry 18 may be located on the left and right edges of display 14, on only a single edge of display 14, or elsewhere in display 14. During operation, row driver circuitry 18 may provide row control signals on horizontal lines 28 (sometimes referred to as row lines or scan lines). Row driver circuitry may sometimes be referred to as scan line driver circuitry.

Column driver circuitry 20 may be used to provide data signals D from display driver integrated circuit 16 onto a plurality of corresponding vertical lines 26. Column driver circuitry 20 may sometimes be referred to as data line driver circuitry or source driver circuitry. Vertical lines 26 are sometimes referred to as data lines. During compensation operations, column driver circuitry 20 may use vertical lines 26 to supply a reference voltage. During programming operations, display data is loaded into display pixels 22 using lines 26.

Each data line 26 is associated with a respective column of display pixels 22. Sets of horizontal signal lines 28 run horizontally through display 14. Each set of horizontal signal lines 28 is associated with a respective row of display pixels 22. The number of horizontal signal lines in each row is determined by the number of transistors in the display pixels 22 that are being controlled independently by the horizontal signal lines. Display pixels of different configurations may be operated by different numbers of scan lines.

Row driver circuitry 18 may assert control signals such as scan signals on the row lines 28 in display 14. For example, driver circuitry 18 may receive clock signals and other control signals from display driver integrated circuit 16 and may, in response to the received signals, assert scan signals and an emission signal in each row of display pixels 22. Rows of display pixels 22 may be processed in sequence, with processing for each frame of image data starting at the top of the array of display pixels and ending at the bottom of the array (as an example). While the scan lines in a row are being asserted, control signals and data signals that are provided to column driver circuitry 20 by circuitry 16 direct circuitry 20 to demultiplex and drive associated data signals D onto data lines 26 so that the display pixels in the row will be programmed with the display data appearing on the data lines D. The display pixels can then display the loaded display data.

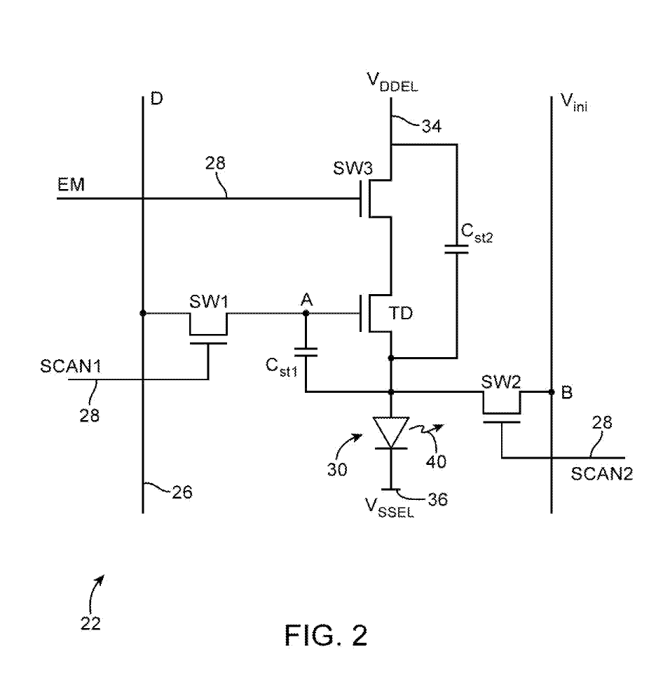

In an organic light-emitting diode display, each display pixel contains a respective organic light-emitting diode. A schematic diagram of an illustrative organic light-emitting diode display pixel 22 is shown in FIG. 2. As shown in FIG. 2, display pixel 22 may include light-emitting diode 30. A positive power supply voltage Vddel may be supplied to positive power supply terminal 34 and a ground power supply voltage Vssel may be supplied to ground power supply terminal 36. The state of drive transistor TD controls the amount of current flowing through diode 30 and therefore the amount of emitted light 40 from display pixel 22.

Display pixel 22 may have storage capacitors Cst1 and Cst2 and one or more transistors that are used as switches such as transistors SW1, SW2, and SW3. Signal EM and scan signals SCAN1 and SCAN2 are provided to a row of display pixels 22 using row lines 28. Data D is provided to a column of display pixels 22 via data lines 26.

Signal EN is used to control the operation of emission transistor SW3. Transistor SW1 is used to apply the voltage of data line 26 to node A, which is connected to the gate of drive transistor TD. Transistor SW2 is used to apply a direct current (DC) bias voltage Vini to node B for circuit initialization during compensation operations.

During compensation operation, display pixels 22 are compensated for pixel-to-pixel variations such as transistor threshold voltage variations. The compensation period includes an initialization phase and a threshold voltage generation phase. Following compensation (i.e., after the compensation operations of the compensation period have been completed, data is loaded into the display pixels. The data loading process, which is sometimes referred to as data programming, takes place during a programming period. In a color display, programming may involve demultiplexing data and loading demultiplexed data into red, green, and blue pixels.

Following compensation and programming (i.e., after expiration of a compensation and programming period), the display pixels of the row may be used to emit light. The period of time during which the display pixels are being used to emit light (i.e., the time during which light-emitting diodes 30 emit light 40) is sometimes referred to as an emission period.

During the initialization phase, circuitry 18 asserts SCAN1 and SCAN2 (i.e., SCAN1 and SCAN2 are taken high). This turns on transistors SW1 and SW2 so that reference voltage signal Vref and initialization voltage signal Vini are applied to nodes A and B, respectively. During the threshold voltage generation phase of the compensation period, signal EM is asserted and switch SW3 is turned on so that current flows through drive transistor TD to charge up the capacitance at node B. As the voltage at node B increases, the current through drive transistor TD will be reduced because the gate-source voltage Vgs of drive transistor TD will approach the threshold voltage Vt of drive transistor TD. The voltage at node B will therefore go to Vref-Vt. After compensation (i.e., after initialization and threshold voltage generation), data is programmed into the compensated display pixels. During programming, emission transistor SW3 is turned off by deasserting signal EM and a desired data voltage D is applied to node A using data line 26. The voltage at node A after programming is display data voltage Vdata. The voltage at node B rises because of coupling with node A. In particular, the voltage at node B is taken to Vref−Vt+(Vdata−Vref)*K, where K is equal to Cst1/(Cst1+Cst2+Coled), where Coled is the capacitance associated with diode 30.

After compensation and programming operations have been completed, the display driver circuitry of display 14 places the compensated and programmed display pixels into the emission mode (i.e., the emission period is commenced). During emission, signal EM is asserted for each compensated and programmed display pixel to turn on transistor EM3. The voltage at node B goes to Voled, the voltage associated with diode 30. The voltage at node A goes to Vdata+(Voled−(Vref−Vt)−(Vdata−Vref)*K. The value of Vgs−Vt for the drive transistor is equal to the difference between the voltage Va of node A and the voltage Vb of node B. The value of Va−Vb is (Vdata−Vref)*(1-K), which is independent of Vt. Accordingly, each display pixel 22 has been compensated for threshold voltage variations so that the amount of light 40 that is emitted by each of the display pixels 22 in the row is proportional only to the magnitude of the data signal D for each of those display pixels.

The amount of time required for initialization and threshold voltage variation (i.e., the compensation period) and the amount of time required for data loading of the red, green, and blue subpixels of each row (i.e., the programming period) cannot be too long without having an adverse impact on the frame rate of the display. Consider, as an example, a display in which the compensation period (i.e., the initialization phase and threshold voltage generation phase) is equal to 18 microseconds and in which the programming period is 12 microseconds. In this illustrative situation, the total time consumed by compensation and programming (sometimes referred to as the row time) will be 30 microseconds. In a conventional progressive emission scheme, the 30 microseconds consumed by the row time of each row will limit the total number of rows that can be provided in the display for a given frame time. If, as an example, it is desired to use a refresh rate of 60 Hz, each frame will be allocated 16 ms. A vertical blanking interval of 3 ms in each frame will reduce the available time to process the rows of display pixels to 13 ms (16 ms−3 ms). If the display were to have 1280 rows, there would only be 10 microseconds of available row time for each row (i.e., 13 ms/1280 rows). As this example demonstrates, a conventional progressive emission scheme cannot be used in a display with 1280 rows and a 60 Hz refresh rate, because 30 microseconds of row time would be required for each row, but only 10 microseconds of row time is available.

To address this problem, the rows of display pixels in display 14 are driven with a hybrid progressive-simultaneous emission scheme. With this type of scheme, sets of multiple rows are compensated simultaneously, thereby saving time that would otherwise be consumed by performing independent compensation operations in each row one after another. Although multiple rows are compensated simultaneously with this approach, the number or rows in each set of simultaneously compensated rows is preferably less than the total number of rows in the display. For example, each set of simultaneously compensated rows may contain eight rows of display pixels in a display with over one thousand rows (as one example). This helps avoid visible artifacts such as flicker that might otherwise be produced by simultaneously processing all of the rows in the array and avoids the reduced lifetime issues that are associated with conventional simultaneous emission schemes.

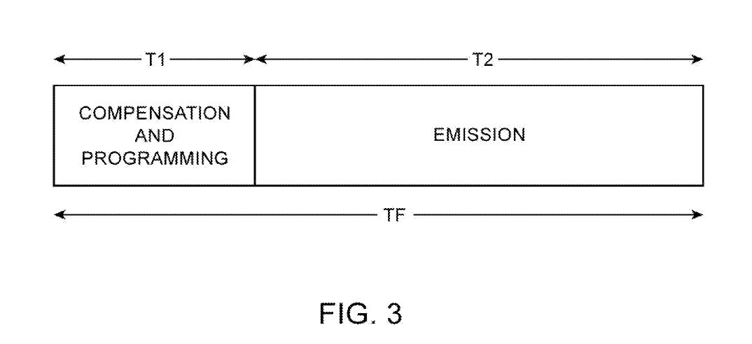

FIG. 3 shows how each row is processed in one frame time TF (e.g., 16 ms or other suitable frame time). The time spent processing each row (i.e., frame time TF) may be allocated between row time T1 (i.e., the time during which the display pixels in the row are being compensated and programmed with data, which is equal to the sum of the compensation period and the programming period) and emission time T2 (i.e., the period during which light-emitting diodes 30 in the row are being driven with data D and are emitting light 40 at intensities proportional to data D in each pixel).

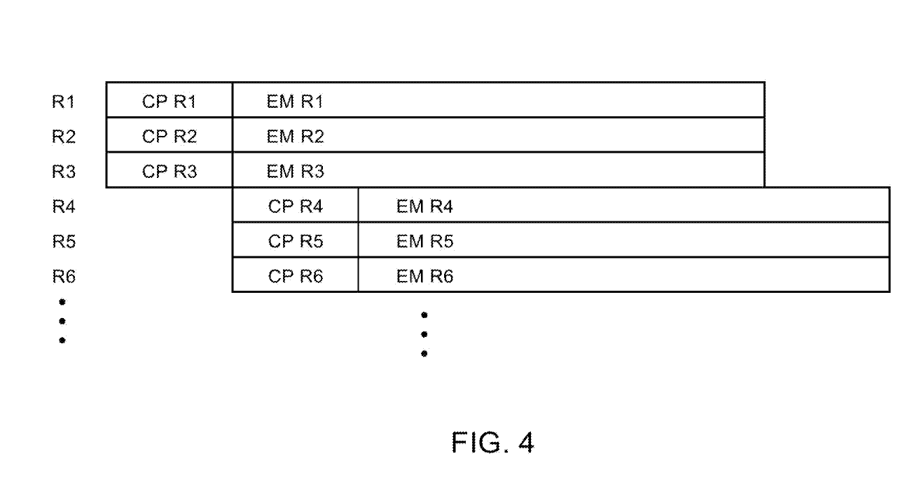

In a hybrid progressive-simultaneous emission scheme, more than a single row (but fewer than the total number of rows in the display) will be processed at a time. This allows all rows to be processed within a desired frame time, even in displays with relatively large numbers of rows. Any suitable number of rows that is less than the total number of rows in the array may be processed simultaneously (e.g., two or more, three or more, four or more, five to ten, two to twenty, more than ten, etc.) FIG. 4 is a diagram of a progressive-simultaneous emission scheme in which three rows are being processed at a time.

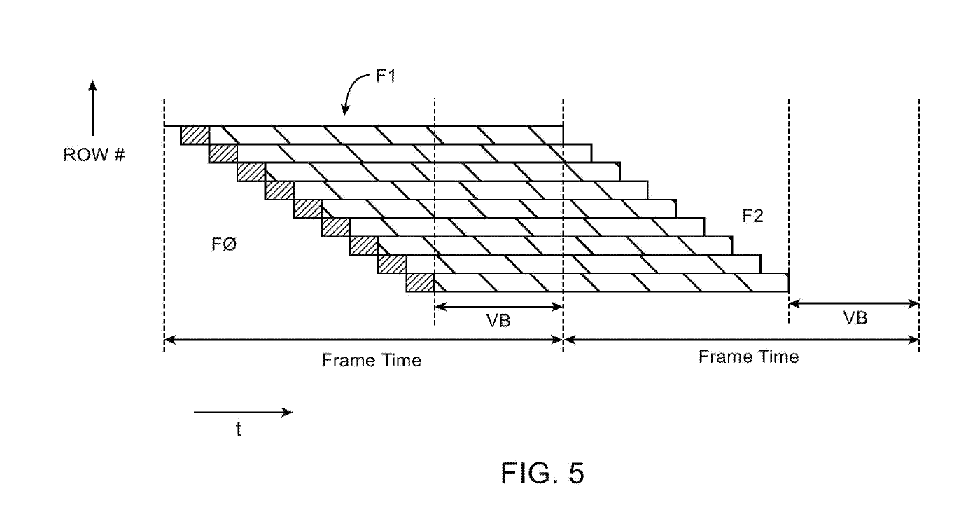

As shown in FIG. 4, processing begins with the first three rows of the display (rows R1-R3). During processing of the first three rows, simultaneous compensation operations are performed followed by successive programming operations for each of the three rows (see, e.g., concurrent compensation and programming periods CPR1, CPR2, and CPR3). Once compensation and programming operations have been completed for the first three rows, emission can be commenced in the first three rows (see, e.g., simultaneous emission periods EM R1, EM R2, and EM R3) and processing can proceed to the next three rows (i.e., rows R4-R6 in the example of FIG. 4). This process can be repeated for the rest of the array, so that all additional sets of rows are processed in the same way. FIG. 5 shows how rows of data for each frame are staggered when using the hybrid progressive-simultaneous emission scheme. In particular, while processing is being finished for frame FO (i.e., when the emission periods of frame FO are being finished), processing for the rows of the next frame (i.e., frame F1) can begin (starting with the first set of rows R1-R3 and continuing with the second set of rows (R4-R6), etc.). Once the first set of rows in frame F1 have finished their emission period, compensation and programming can be started for the first set of rows in the next frame (i.e., frame F2). This process is continuous, so that as the last rows of each frame are still being displayed, the first rows of the following frame are beginning to be displayed. Row processing is performed in sets of two or more rows, so that a desired number of rows can be accommodated within a potentially limited frame time.

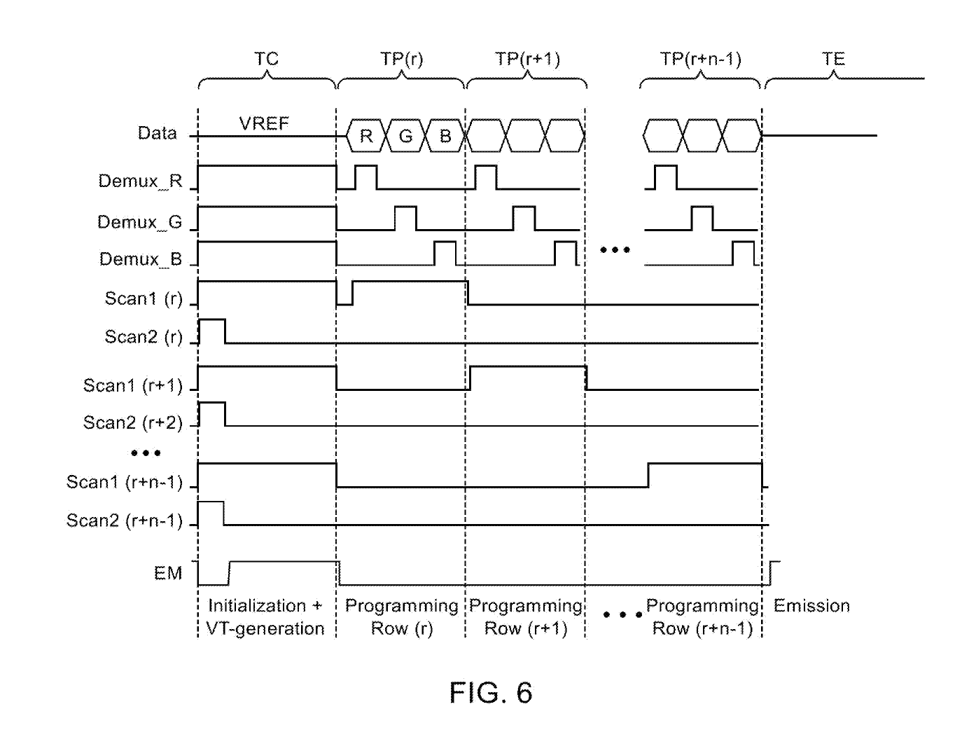

FIG. 6 is a timing diagram for an illustrative hybrid progressive-simultaneous emission scheme. During time period TC, n multiple rows of display pixels are compensated simultaneously (i.e., the initialization phase and the threshold voltage generation phase is performed concurrently for a set of n rows in the array). Because compensation operations are being performed concurrently, the overall row processing time used for processing this set of rows is being reduced (i.e., there is a time savings associated with compensating multiple rows at a time). During these concurrent compensation operations, data lines 26 can carry commonly used reference voltage Vref to each of the multiple rows at the same time (i.e., the data lines can be shared for distribution of voltage Vref to multiple rows at once). Any suitable number n of rows can be simultaneously processed in this way (e.g., the value of n may be two, three, eight, more than ten, etc.). The number of rows that is simultaneously processed in each set is preferably less than the total number of rows in the array.

Following the simultaneous compensation of rows r through r+n−1 (in the FIG. 6 example), each of these rows is individually programmed in sequence. For example, row r may be programmed during time period TP(r), row r+1 may then be programmed during time period TP(r+1), etc. Emission period TE may be simultaneously started for each of rows r to r+n−1 once sequential programming of each of the rows has been completed.

After the first set of n rows has been compensated and programmed and after beginning the emission period for each of the first set of n rows, processing for the subsequent set of n rows can be started. This process may be performed continuously so that all additional sets of rows are processed in the same way. Processing may then commence for the next frame, as shown in FIG. 5.

The foregoing is merely illustrative and various modifications can be made by those skilled in the art without departing from the scope and spirit of the described embodiments. The foregoing embodiments may be implemented individually or in any combination.

What is claimed is:

1. A display comprising:
an array of display pixels arranged in rows and columns, wherein the array has a total number of rows;
row lines associated with the rows of the display pixels;
column lines associated with the columns of the display pixels; and
display driver circuitry configured to simultaneously compensate a given number of rows of the display pixels for threshold voltage variations, wherein the given number of rows is more than one and less than the total number or rows.

2. The display defined in claim 1 wherein each display pixel has a light-emitting diode.

3. The display defined in claim 2 wherein each display pixel has a thin-film drive transistor with an associated drive transistor threshold voltage and wherein the display driver circuitry is configured to simultaneously compensate the given number of rows of the display pixels for variations in the associated drive transistor threshold voltages.

4. The display defined in claim 3 wherein the display driver circuitry is configured to sequentially program each of given number of rows with display data following simultaneous compensation of the given number of rows.

5. The display defined in claim 4 wherein the light-emitting diode comprises an organic light-emitting diode.

6. The display defined in claim 5 wherein the display driver circuitry is configured to place the given number of rows in an emission period in which the organic light-emitting diode of each of the display pixels in each of the given number of rows emits light.

7. The display defined in claim 6 wherein the display driver circuitry is configured to process additional rows of the display pixels and wherein during the processing of the additional rows of display pixels, more than one of the additional rows of display pixels are simultaneously compensated for threshold voltage variations.

8. The display defined in claim 3 wherein the display driver circuitry is configured to simultaneously compensate the given number of rows of the display pixels by providing a common reference voltage over the column lines.

9. A method for operating a display having an array of display pixels arranged in rows and columns, wherein the array has a total number of rows, the method comprising:
simultaneously compensating a given set of the rows of the display pixels for thin-film transistor threshold variations, wherein the given set of the rows has multiple rows and has fewer than the total number of rows; and
after simultaneously compensating the given set of rows, loading display data into the display pixels of the given set of rows.

10. The method defined in claim 9 further comprising emitting light with the display pixels that have been loaded with the display data.

11. The method defined in claim 10 wherein loading the display data comprises sequentially loading display data into each of the rows in the given set of rows.

12. The method defined in claim 11 wherein loading the display data comprises loading the display data into each of the rows using column lines that are associated with respective columns of the array.

13. The method defined in claim 12 wherein each display pixel includes a drive transistor with a threshold voltage, wherein simultaneously compensating the given set of rows comprises simultaneously compensating the drive transistors of each of the display pixels in the given set of rows by providing each of the display pixels in the given set of rows with a common reference voltage using the column lines.

14. The method defined in claim 13 wherein the display pixels comprise organic light-emitting diode display pixels each of which contains a corresponding organic light-emitting diode driven by a respective one of the drive transistors and wherein emitting light with the display pixels comprises emitting light with the organic light-emitting diodes.

15. The method defined in claim 11 further comprising:
after simultaneously compensating the given set of rows and after loading the display data into the display pixels of the given set of rows, processing additional sets of rows one set after another by simultaneously compensating each of the rows in each additional set of rows and by sequentially loading the display data into the display pixels of each additional set of rows.

16. The method defined in claim 11 wherein emitting light with the display pixels that have been loaded with the display data comprises simultaneously commencing emission periods for each of the rows of display pixels in the given set of rows.

17. An organic light-emitting diode display, comprising:
display driver circuitry that receives image data to be displayed on the display in a series of frames each having a frame time;
an array of display pixels having rows and columns, wherein the array of display pixels has a total number of rows;
data lines each of which is associated with a respective one of the columns of display pixels; and
scan lines that are associated with the rows of display pixels, wherein the display driver circuitry is configured to use the data lines and the scan lines to simultaneously provide a common reference voltage to each row of display pixels in a given number of the rows and wherein the given number of the rows is more than one and is less than the total number of TOWS.

18. The organic light-emitting diode display defined in claim 17 wherein each display pixel has at least first, second, and third transistors, wherein the first transistor in each display pixel is a drive transistor having a threshold voltage and wherein the display driver circuitry is configured to simultaneously compensate the display pixels in the given number of rows for variations in the threshold voltages of the drive transistors in the display pixels of the given number of rows by simultaneously providing the common reference voltage to the display pixels of the given number of rows.

19. The organic light-emitting diode display defined in claim 18 wherein the display driver circuitry is configured to sequentially load display data into each of the rows of display pixels in the given number of rows that have been simultaneously compensated.

20. The organic light-emitting diode display defined in claim 19 wherein the display driver circuitry is configured to simultaneously assert an emission signal in each row of the given number of rows, wherein the second transistors in each row comprise emission transistors that receive the emission signal of that row, and wherein each emission transistor is coupled to a respective one of the drive transistors.
